(19) United States
(12) Patent Application Publication
(10) Pub. No.: US 2026/0164420 A1
(43) Pub. Date: Jun. 11, 2026

(54) BWP SWITCHING

(71) Applicant: Lenovo (Beijing) Limited, Beijing (CN)

(72) Inventors: Zhi Yan, Beijing (CN); Hongmei Liu, Beijing (CN); Yuantao Zhang, Beijing (CN); Ruixiang Ma, Beijing (CN); Yingying Li, Beijing (CN); Haiming Wang, Beijing (CN)

(73) Assignee: Lenovo (Beijing) Limited, Beijing (CN)

(21) Appl. No.: 19/127,060

(22) PCT Filed: Nov. 4, 2022
(86) PCT No.: PCT/CN2022/129939

§ 371 Date: May 2, 2025

(51) Int. Cl. H04W 72/0457; H04L 27/26; H04W 72/20

(52) U.S. Cl. CPC H04W 72/0457; H04L 27/26025; H04W 72/20

(57) ABSTRACT

Methods and apparatuses for UE group based BWP switching are disclosed. In an embodiment, a UE comprises a transceiver; and a processor coupled to the transceiver, wherein the processor is configured to receive, via the transceiver, a configuration of BWPs for a numerology; and receive, via the transceiver, a control signal in a first BWP in a first BWP set, the control signal indicates BWP switching from the first BWP to a second BWP, wherein, the first BWP set is comprised of at least the configured BWPs for the numerology.

### FIELD

The subject matter disclosed herein generally relates to wireless communications, and more particularly relates to methods and apparatuses for BWP switching.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Bandwidth Part (BWP), Resource Block (RB), Carrier Resource Block (CRB), Physical Resource Block (PRB), Physical Downlink Control Channel (PDCCH), Downlink Control Information (DCI), Medium Access Control (MAC), Time Division Duplex (TDD), Frequency Division Duplex (FDD), energy saving (ES).

Carrier Bandwidth Part (BWP) is a contiguous set of physical resource blocks, selected from a contiguous subset of the common resource blocks for a given numerology on a given carrier.

UE can be UE-specifically configured with up to 4 BWPs in DL and UL separately.

FIG. 1 illustrates an example of three configured BWPs.

Multiple BWPs (e.g., 3 BWPs) are configured in a carrier band. CRB stands for Carrier Resource Block, which is numbered from the one end through the other end of the carrier band. CRB is a kind of global resource block. On the other hand, PRB stands for Physical Resource Block, which is numbered within each BWP.

Point A indicates a common reference point for resource block grids and is obtained from the following higher layer parameters: n_{CRB}=N_{BWPx,start}+n_{PRB}.

n_{CRB} indicates a resource block location in common resource block (i.e., in a carrier band). n_{PRB} indicates a resource block within a specific carrier bandwidth part. In other words, n_{CRB} is a position in an absolute (reference) coordinate system, and n_{PRB} is a position in a relative coordinate system.

There are several different types of BWPs: initial BWP, first active BWP, default BWP and (regular) BWPs.

The initial BWP, represented by initialDownlinkBWP, is a dedicated (UE-specific) configuration for the initial downlink bandwidth-part (i.e., DL BWP#0).

The first active BWP, represented by firstActiveDownlinkBWP-Id, is the BWP to be active right after the initial attach (or NR addition) is completed.

The default BWP, represented by defaultDownlinkBWP-Id, indicates the BWP that UE or the network automatically switches to when there is no activity in current BWP until a predetermined timer (e.g., bwp-InactivityTimer).

Incidentally a BWP-ID is an identifier for a BWP. BWP ID=0 is always associated with the initial BWP.

Take the DL BWP as an example, suppose there are four configured DL BWPs (e.g., DL BWP#1, DL BWP#2, DL BWP#3, DL BWP#4), the relation among the initial DL BWP, the configured BWPs, the first active DL BWP, and the default DL BWP is illustrated in FIG. 2. The initial DL BWP is DL BWP #0. The configured DL BWPs include DL BWP#1, DL BWP#2, DL BWP#3, and DL BWP#4. The first active BWP is preconfigured as one of DL BWP #0, DL BWP#1, DL BWP#2, DL BWP#3, and DL BWP#4. The default BWP is preconfigured as one of DL BWP #0, DL BWP#1, DL BWP#2, DL BWP#3, and DL BWP#4.

The frequency domain location and bandwidth of a BWP are represented by locationAndBandwidth, the value of which can be interpreted as resource indicator value (RIV).

Even though multiple BWPs can be defined in DL and UL separately, only one BWP can be active at each specific moment. It implies there is some mechanism to select a specific BWP as the active (or activated) BWP. BWP selection (or BWP switching) can be done by one of the following ways:
(1) By PDCCH (i. e, DCI): A specific BWP can be activated by bandwidth part indicator in DCI Format 0_1 (a UL Grant) and DCI Format 1_1 (a DL Schedule). The network (e.g., the gNB) may trigger the UE to switch UL or DL BWP using a DCI field. The four code points in that DCI field map to the RRC-configured BWP-ID as follows: For up to 3 configured BWPs (in addition to the initial BWP), the DCI code point is equivalent to the BWP ID (initial BWP ID=0, first dedicated BWP ID=1, . . . , etc). If the network configures 4 dedicated BWPs, they are identified by DCI code points 0 to 3. In this case, it is not possible to switch to the initial BWP using the DCI field.
(2) By the bwp-Inactivity Timer: UE falls back to the default BWP after the timer duration. Incidentally, if the network releases the timer configuration, the UE stops the timer without switching to the default BWP.
(3) By RRC signaling: UE receives RRC signaling reconfiguration, which is configured with first active BWP, UE activates (i.e., switches to) the first active BWP.
(4) By the MAC entity itself upon initiation of random access procedure: Upon initiation of the random access procedure on a serving cell, UE may switch to initial BWP.

In NR Release 17, UE-specific BWP configuration and switching is supported, and UE can be configured or indicated to switch among up to 4 BWPs for DL and UL separately. Considering the gNB power saving, it is preferable that UE should be configured to work in smaller BWP in gNR energy saving mode and that activated BWPs among all UEs are aligned in gNB side to reduce carrier bandwidth. As illustrated in FIG. 3, if UE #1 and UE #4 perform BWP switching as indicated, all UEs (i.e., UE #1, UE #2, UE #3 and UE #4) can occupy reduced carrier bandwidth.

In the above-described BWP switching by DCI, the BWP switching can be only done UE-specifically. In addition, the DCI used for UE-specifically BWP switching has to include uplink or downlink scheduling, which may be resource waste. In view of the above, it is preferable to perform BWP switching on a basis of a group of UEs and without uplink or downlink scheduling.

This invention targets ue group based BWP switching.

### BRIEF SUMMARY

Methods and apparatuses for UE group based BWP switching are disclosed.

In an embodiment, a UE comprises a transceiver; and a processor coupled to the transceiver, wherein the processor is configured to receive, via the transceiver, a configuration of BWPs for a numerology; and receive, via the transceiver, a control signal in a first BWP in a first BWP set, the control signal indicates BWP switching from the first BWP to a second BWP, wherein, the first BWP set is comprised of at least the configured BWPs for the numerology.

In some embodiment, the second BWP is one of default BWP, initial BWP, first active BWP and energy saving BWP(s) in the first BWP set, or among the BWPs in the first BWP set, one of the BWP with the highest frequency, the BWP with the lowest frequency, the BWP with the largest frequency bandwidth, the BWP with the smallest frequency bandwidth, the BWP with the lowest BWP index, the BWP with the highest BWP index and some combinations thereof, or among the BWPs in the first BWP set, a single BWP that meets a predefined requirement.

In some embodiment, the second BWP is indicated by the control signal from candidate BWPs in a second BWP set. The candidate BWPs in the second BWP set may be a subset of the first BWPs in the first BWP set.

In some embodiment, each candidate BWP in the second BWP set is one of default BWP, initial BWP, first active BWP and energy saving BWP(s) in the first BWP set, or among the BWPs in the first BWP set, one of BWP(s) with higher frequency(ies), BWP(s) with lower frequency(ies), BWP(s) with larger frequency bandwidth(s), BWP(s) with lower frequency bandwidth(s), BWP(s) with lower BWP index(ices), BWP(s) with higher BWP index(ices) in the first BWP set, and some combinations thereof.

In some embodiment, the second BWP set includes BWP(s) in the first BWP set that meet a requirement. The requirement may be related to at least one of BWP bandwidth, frequency start of BWP and frequency end of BWP. In a first implementation, the second BWP set includes BWP(s) in the first BWP set that have BWP bandwidth not larger than or not smaller than that of the first BWP in the first BWP set. In a second implementation, the second BWP set includes BWP(s) in the first BWP set that have the lowest frequency start of BWP, the highest frequency start of BWP, the lowest frequency end of BWP, or the highest frequency end of BWP. In a third implementation, the second BWP set includes BWP(s) in the first BWP set that are within a frequency range of BWP. The frequency range of BWP may be indicated in the control signal. In addition, the candidate BWPs may be indexed in increasing or decreasing order in the second BWP set according to their BWP IDs in the first BWP set, BWP bandwidth, frequency start of BWP, or frequency end of BWP.

In some embodiment, the control signal further indicates the activation of a semi-persistent transmission or a configured granted transmission in the second BWP. The transmission configuration associated with the first BWP in the first BWP set may be adopted to transmission configuration associated with the second BWP. The bandwidth of resource assignment associated with the first BWP in the first BWP set may be adopted to that associated with the second BWP. The start of the resource assignment associated with the second BWP may be determined by at least one of the frequency start, the frequency end and the bandwidth of the second BWP.

In another embodiment, a base unit comprises a transceiver; and a processor coupled to the transceiver, wherein the processor is configured to transmit, via the transceiver, a configuration of BWPs for a numerology; and transmit, via the transceiver, a control signal, the control signal indicates a BWP switching from a first BWP in a first BWP set to a second BWP, wherein, the first BWP set is comprised of at least the configured BWPs for the numerology.

In yet another embodiment, a method of a UE comprises receiving a configuration of BWPs for a numerology; and receiving a control signal in a first BWP in a first BWP set, the control signal indicates BWP switching from the first BWP to a second BWP, wherein, the first BWP set is comprised of at least the configured BWPs for the numerology

In a further embodiment, a method of a base unit comprises transmitting a configuration of BWPs for a numerology; and transmitting a control signal, the control signal indicates a BWP switching from a first BWP in a first BWP set to a second BWP, wherein, the first BWP set is comprised of at least the configured BWPs for the numerology.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of three configured BWPs;

FIG. 2 illustrates the relation among the initial DL BWP, the configured BWPs, the first active DL BWP, and the default DL BWP;

FIG. 3 illustrates an example of reduced carrier bandwidth;

FIG. 4 illustrates the relation among the initial DL BWP, the first active DL BWP, the default DL BWP, the ES DL BWP (1) and the DL BWPs;

FIG. 5 illustrates an example of the third sub-embodiment of the first embodiment;

FIG. 6 illustrates an example of the offset;

FIG. 7 illustrates an example of determining the offset;

FIG. 8 is a schematic flow chart diagram illustrating an embodiment of a method;

FIG. 9 is a schematic flow chart diagram illustrating another embodiment of a method; and

FIG. 10 is a schematic block diagram illustrating apparatuses according to one embodiment.

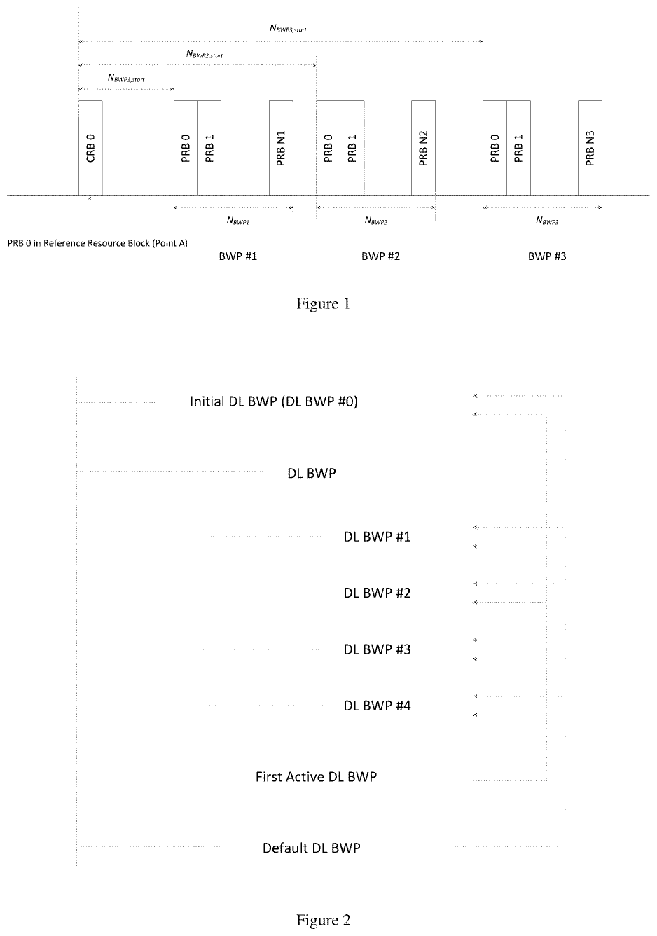

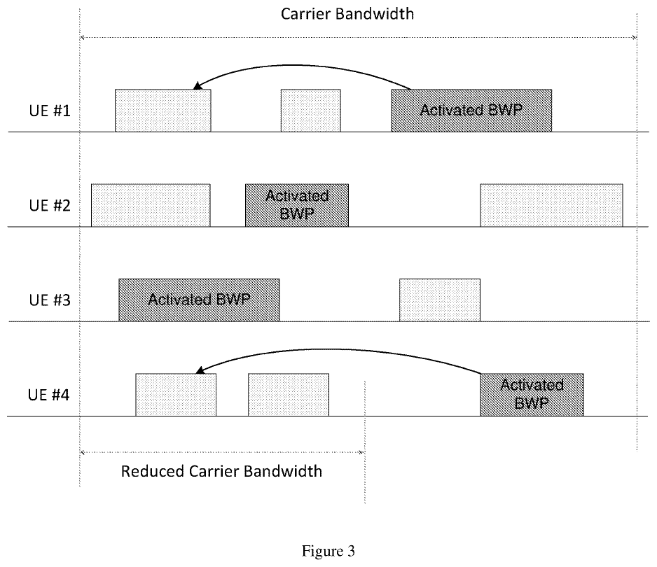

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The BWP switching can be applied to both DL BWP switching and UL BWP switching. For TDD, each UL BWP corresponds to one DL BWP. It means that when a DL BWP is switched to another DL BWP, the UL BWP corresponding to the DL BWP is switched to the other UL BWP corresponding to the DL BWP. For FDD, the UL BWP and the DL BWP are switched separately.

For ease of discussion, in the following description, the BWP switching is described by example of DL BWP switching. For TDD, the UL BWP is switched based on the DL BWP switching, or vice versa. For FDD, the same principle of DL BWP switching applies to UL BWP switching.

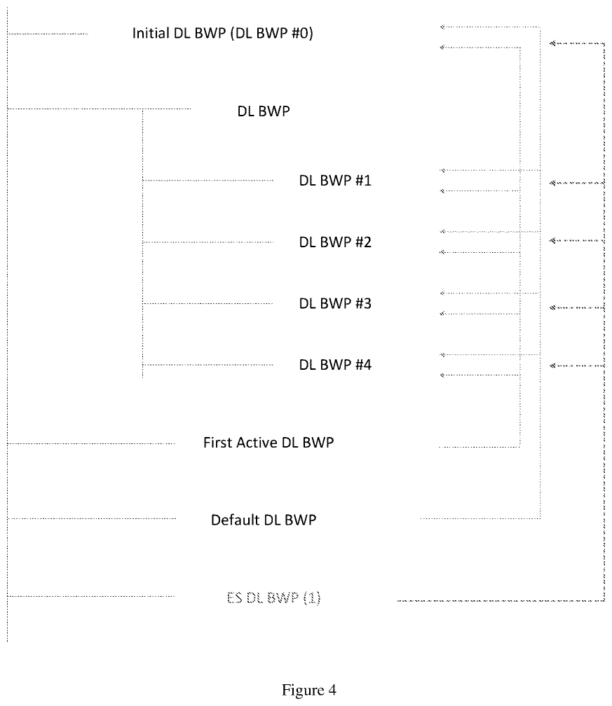

A UE is UE-specifically configured with a first BWP set including multiple BWPs (e.g., 4 DL BWPs) for a numerology. The expression “UE-specifically” means that each UE can be configured with a first UE BWP set separately. The first BWP set may include an initial BWP (i.e., BWP #0), and up to 4 configured BWPs (e.g., DL BWP #1, DL BWP #2, DL BWP #3, DL BWP #4). The first BWP set also include first active BWP (e.g., first active DL BWP), which is preconfigured as one of the initial BWP and the configured BWPs of the first BWP set; and default BWP (e.g., default DL BWP), which is preconfigured as one of the initial BWP and the configured BWPs of the first BWP set. UE can be additionally configured with energy saving (ES) BWP(s) (e.g., ES DL BWP(s)) for network energy saving consideration, each of which is preconfigured as one of the initial BWP and the configured BWPs of the first BWP set by being associated with a BWP ID (e.g., DL BWP ID). Note that one or multiple ES BWPs can be configured. The ES BWP(s) (e.g., ES DL BWP(s)) are configured in consideration of energy saving at the network side (e.g., at gNB). The number of configured ES BWP(s) for each UE and the bandwidth (including the start and the end of the bandwidth) of each configured ES BWP depend on gNB implementation. As a general principle, it is preferable that the ES BWPs of all UEs (or of at least a group of UEs) are configured in a same or similar bandwidth range and that the bandwidth of ES BWP can be as small as possible. The relation among the initial DL BWP, the first active DL BWP, the default DL BWP, the ES DL BWP (1) (suppose that only one ES DL BWP is configured) and the DL BWPs (i.e., DL BWP #1, DL BWP #2, DL BWP #3, DL BWP #4) is illustrated in FIG. 4. Incidentally, the initial BWP can be configured in SIB1. If the initial BWP is not configured in SIB1, the frequency range and position of CORESET 0 is regarded as the initial BWP by default. It implies that, the initial BWP may not be actually configured. As a whole, the first BWP set is comprised of at least the configured BWPs for a numerology, and optionally the initial BWP by default (which has the frequency range and position of CORESET 0).

At any time, only one DL BWP is activated for a UE. BWP #x represents the activated BWP for the UE. It is apparent that BWP #x is one BWP included in the first BWP set configured to the UE. All BWPs included in the first set, that is, either each of the initial BWP (e.g., BWP #0, or the frequency range and position of CORESET 0 if initial BWP is not configured) and the configured BWPs (e.g., BWP #1, BWP #2, BWP #3, BWP #4), or the first active DL BWP, the default DL BWP and each ES DL BWP, each of which is preconfigured as one of the initial BWP and the configured BWPs, can be referred to as “first BWP”.

According to a first embodiment, the UE receives a control signal (e.g., a DCI) in BWP #x of the configured first BWP set. The control signal dynamically indicates to the UE to switch from BWP #x to BWP #y.

BWP #y can be a preconfigured BWP, or a candidate BWP in a second BWP set. The preconfigured BWP can be one BWP selected from the first BWP set, or a new BWP (i.e., a BWP not included in the first BWP set). The second BWP set includes one or multiple candidate BWPs. In particular, the second BWP set includes at least a subset of the BWPs in the first BWP set. Incidentally, the second BWP set may further include new BWP(s) that are not included in the first BWP set.

The control signal is transmitted from the network (e.g., gNB) on a specific frequency range. The UEs, the activated BWP (i.e., BWP #x) of each of which covers the specific frequency range, can receive the control signal. All of the UEs that can receive the control signal are referred to as a group of UEs. It means that the control signal indicates to each UE in the group of UEs to switch from BWP #x to BWP #y.

The DCI may include a BWP switching field having one or multiple bits to indicate the BWP switching.

The BWP switching field can be understood by one of the following manners.

Manner 1: the BWP switching field has one bit, i.e., has a value ‘0’ or a value ‘1’.In manner 1, ‘0’ indicates BWP switching, while ‘1’ indicates no switching (i.e., keeping in currently activated BWP). In this condition, only when the UE (any UE in the group of UEs that can receive the control signal) receives the control signal including a BWP switching field set to ‘0’, the BWP switching will be performed. In this assumption, the BWP will be switched from BWP #x to the predetermined BWP #y.

Manner 2: the BWP switching field has one or multiple bits. If the UE receives the control signal, the BWP switching will be performed. The possible values of the BWP switching field indicate different candidate BWPs included in the second BWP set to be switched to. For example, if the BWP switching field has one bit, i.e., the possible values can be ‘0’ or ‘1’, the second BWP set for each UE may include at least two candidate BWPs, where ‘0’ indicates that the BWP will be switched from BWP #x to the first candidate BWP while ‘1’ indicates that the BWP will be switched from BWP #x to the second candidate BWP. For another example, if the BWP switching field has two bits, i.e., the possible values can be ‘00’, ‘01’, ‘10’ or ‘11’, the second BWP set for each UE may include four candidate BWPs.

Manner 3: the BWP switching field has one or multiple bits. If the UE receives the control signal, the BWP switching will be performed to one of the candidate(s) included in the second BWP set. Alternatively to Manner 2, the second BWP set for each UE may include candidate BWP(s) meeting a certain requirement. The possible value(s) of the BWP switching field may depend on the number of candidate BWP(s) included in the second BWP set for each UE (e.g., the smallest number of BWP(s) included in the second BWP set for each UE). The number of bit(s) of the BWP switching field may be fixed, e.g., as 1 or 2. For example, if the BWP switching field has one bit, the possible values can be ‘0’ or ‘1’. The value ‘0’ indicates that each UE shall be switched to the first BWP (e.g., BWP with ID #0) included in the second BWP set meeting the certain requirement, while the value ‘1’ indicates that each UE shall be switched to the second BWP (e.g., BWP with ID #1) included in the second BWP set meeting the certain requirement. It means that the BWP(s) included in the second BWP set shall be indexed from ID #0.

According to a first sub-embodiment of the first embodiment, the BWP switching field has one bit and is understood as in Manner 1. In the first sub-embodiment, BWP #y is preconfigured (or predetermined).

The predetermined BWP (i.e., BWP #y) can be one of the BWPs configured in the first BWP set. For a first example, the predetermined candidate BWP (e.g., BWP #y) can be one of the initial BWP, the first active BWP, the default BWP and energy saving (ES) BWP(s) of the first BWP set, e.g., the initial BWP. In the first example, the predetermined BWP is explicitly predetermined.

For a second example, the predetermined BWP (i.e., BWP #y) can be, among the BWPs of the first BWP set, one of the BWP with the highest frequency (e.g., highest frequency end of all BWPs in the first BWP set), the BWP with the lowest frequency (e.g., lowest frequency start of all BWPs in the first BWP set), the BWP with the largest frequency bandwidth, the BWP with the smallest frequency bandwidth, the BWP with the lowest BWP index (e.g., BWP #0), the BWP with the highest BWP index (e.g., BWP #4) and some combinations thereof. An example of combination is described: if there are multiple (e.g., two) BWPs with the largest frequency bandwidth, the BWP with the lowest BWP index and the largest frequency bandwidth can be the predetermined BWP. In the second example, the predetermined BWP is implicitly predetermined.

For a third example, the predetermined BWP (i.e., BWP #y) can be, among the BWPs of the first BWP set, one BWP meeting a requirement. For example, the requirement is related to at least a frequency range. If there are more than one BWP among the BWPs of the first BWP set meeting the requirement, the one BWP can be determined by a further requirement, e.g., with the lowest BWP index, with the highest BWP index, or with the largest frequency bandwidth within the frequency range, etc.

It is up to gNB implementation to determine, among the configured BWPs in the first BWP set, which one of the initial DL BWP, the first active DL BWP, the default DL BWP, and the ES DL BWP (e.g., any of BWP #0, BWP #1, BWP #2, BWP #3, and BWP #4), the BWP with the highest frequency, the BWP with the lowest frequency, the BWP with the largest frequency bandwidth, the BWP with the smallest frequency bandwidth, the BWP with the lowest BWP index, and the BWP with the highest BWP index, or some combinations thereof is explicitly or implicitly preconfigured as the predetermined BWP (i.e., BWP #y).

If the initial BWP configured in the first BWP set is determined as the predetermined BWP (i.e., BWP #y), and if the UE receives a DCI including a BWP switching field with a value ‘0’, the UE will switch the BWP from BWP #x to the initial BWP.

According to a second sub-embodiment of the first embodiment, the BWP switching field has one or multiple (e.g., two) bits and is understood as in Manner 2. In the second sub-embodiment, the second BWP set for each UE includes a number of candidate BWPs that can be indicated by the values of the BWP switching field. For example, if the BWP switching field has one bit, the second BWP set for each UE includes up to 2 (=2¹) candidate BWPs (e.g., candidate BWP #0, candidate BWP #1 for each UE), while value ‘0’ of the BWP switching field may indicate candidate BWP #0 and value ‘1’ of the BWP switching field may indicate candidate BWP #1. If the BWP switching field has two bits, the second BWP set for each UE includes up to 4 (=2²) candidate BWPs (e.g., candidate BWP #0, candidate BWP #1, candidate BWP #2, candidate BWP #3 for each UE), while value ‘00’ of the BWP switching field may indicate candidate BWP #0, value ‘01’ of the BWP switching field may indicate candidate BWP #1, value ‘10’ of the BWP switching field may indicate candidate BWP #2, value ‘11 of the BWP switching field may indicate candidate BWP #3.

The candidate BWPs in the second BWP set can be determined at least from the BWPs configured in the first BWP set.

Each candidate BWP (e.g., each of candidate BWP #0, candidate BWP #1, candidate BWP #2, and candidate BWP #3) in the second BWP set can be explicitly or implicitly determined.

If a candidate BWP in the second BWP set is explicitly determined, it can be one of the initial BWP, the first active BWP, the default BWP and energy saving (ES) BWP(s) of the first BWP set.

If a candidate BWP in the second BWP set is implicitly determined, it can be, among the BWPs of the first BWP set, one of BWP(s) with higher frequency(ies), BWP(s) with lower frequency(ies), BWP(s) with larger frequency bandwidth(s), BWP(s) with lower frequency bandwidth(s), BWP(s) with lower BWP index(ices), and BWP(s) with higher BWP index(ices), or some combinations thereof.

According to a third sub-embodiment of the first embodiment, the BWP switching field has one or multiple (e.g., two) bits and is understood as in Manner 3. In the third sub-embodiment, the candidate BWP(s) in the second BWP set for each UE are determined according to a certain requirement or metric. The certain requirement can be at least one of BWP bandwidth (e.g., equivalent RB numbers for a given or reference numerology, or RB numbers no matter of the numerology), frequency start of BWP and frequency end of BWP or some combination thereof.

Some examples of the requirement are as follows:

For a first example, the BWP(s) of the first BWP set that have a BWP bandwidth not larger than or not smaller than that of BWP #x (i.e., currently activated BWP) meet the requirement. For example, to guarantee the UE traffic (or load), the BWP bandwidth should not be smaller than the currently activated BWP.

For a second example, to guarantee the BWP alignment among multiple UEs, the frequency start or frequency end of BWPs can be restricted to a frequency range. For example, the second BWP set includes the BWP(s) in the first BWP set that have the lowest frequency start of BWP, the highest frequency start of BWP, the lowest frequency end of BWP, or the highest frequency end of BWP.

For a third example, the BWP(s) of the first BWP set that have a frequency range within thresholds (i.e., within lower threshold and higher threshold) meet the requirement, where the thresholds can be configured by higher layers or dynamically indicated in the control signal. For example, multiple threshold pairs (where a threshold pair refers to a lower threshold and a higher threshold) are configured by higher layer and one of the threshold pairs is indicated in the control signal, e.g., by a threshold field.

When the BWP(s) in the first BWP set meeting the requirement are determined (e.g., for each UE) as the candidate BWP(s) in the second BWP set, they are indexed in the second BWP set according to their BWP ID(s) in the first BWP set in increasing or decreasing order. Alternatively, they are indexed according to increasing or decreasing order of BWP bandwidth, frequency start of BWP, or frequency end of BWP.

For example, UE is configured with initial DL BWP (e.g., BWP #0) and 4 DL BWPs (e.g., BWP #1, BWP #2, BWP #3, BWP #4) as follows:
BWP #0: n_{CRB} ranging from RB number 0 to RB number 9;
BWP #1: n_{CRB} ranging from RB number 20 to RB number 39;
BWP #2: n_{CRB} ranging from RB number 30 to RB number 59;
BWP #3: n_{CRB} ranging from RB number 120 to RB number 199; and
BWP #4: n_{CRB} ranging from RB number 20 to RB number 99.

That is, the first BWP set includes BWP #0, BWP #1, BWP #2, BWP #3, and BWP #4

The requirement is the BWP having a frequency range within thresholds.

If the frequency thresholds are configured as lower threshold=RB number 0 and higher threshold=RB number 60 for a given numerology (e.g., predefined numerology or default numerology), then BWP #0, BWP #1 and BWP #2 in the first BWP set meet the requirement while BWP #3 and BWP #4 in the first BWP set do not meet the requirement. Accordingly, the second BWP set include BWP #0, BWP #1 and BWP #2 of the first BWP set with index of {0, 1, 2}, i.e., in increasing order of BWP ID. It means that the second BWP set includes three BWPs: BWP #0 that is BWP #0 in the first BWP set, BWP #1 that is BWP #1 in the first BWP set, and BWP #2 that is BWP #2 in the first BWP set. The UE receives the control signal including BWP switching field having two bits. If the value of the BWP switching field is ‘00’, the UE shall switch to BWP #0 in the second BWP set; if the value of the BWP switching field is ‘01’, the UE shall switch to BWP #1 in the second BWP set; if the value of the BWP switching field is ‘10’, the UE shall switch to BWP #2 in the second BWP set. It is up to implementation on whether the value ‘11’ of the BWP switching field is acceptable. If the value ‘11’ of the BWP switching field is acceptable, it may indicate no BWP switching, i.e., keeping in current BWP (i.e., keeping in BWP #x). Alternatively, the UE may receive the control signal including BWP switching field one bit. In this condition, if the value of the BWP switching field is ‘0’, the UE shall switch to BWP #0 in the second BWP set; if the value of the BWP switching field is ‘1’, the UE shall switch to BWP #1 in the second BWP set.

Another example is illustrated in FIG. 5. UE is configured with 4 DL BWPs (e.g., BWP #1, BWP #2, BWP #3, BWP #4) as follows:
BWP #1: n_{CRB} ranging from RB number 20 to RB number 39, with a total of 20 RBs
BWP #2: n_{CRB} ranging from RB number 110 to RB number 119, with a total of 20 RBs
BWP #3: n_{CRB} ranging from RB number 140 to RB number 169, with a total of 30 RBs
BWP #4: n_{CRB} ranging from RB number 170 to RB number 199, with a total of 30 RBs

That is, the first BWP set includes BWP #1, BWP #2, BWP #3 and BWP #4.

The requirement is the BWP having a frequency range within thresholds (i.e., within lower threshold and higher threshold) and having a bandwidth no smaller than a bandwidth threshold.

If the frequency thresholds are configured with lower threshold=RB number 100 and higher threshold=RB number 200, and the bandwidth threshold (for a given numerology) is configured with 30 RBs (i.e., at least 30 RBs), then BWP #3 and BWP #4 in the first BWP set meet the requirement, while BWP #1 and BWP #2 in the first BWP set do not meet the requirement (since BWP #1 is not within RB number from 100 to 200; BWP #2 does not have a total of at least 30 RBs). Accordingly, the second BWP set include BWP #3 and BWP #4 in the first BWP set with index of {0, 1}. It means that the second BWP set includes two BWPs: BWP #0 that is BWP #3 in the first BWP set, and BWP #1 that is BWP #4 in the first BWP set. The UE receives the control signal including BWP switching field having one or two bits. Suppose that the BWP switching field has one bit, if the value of the BWP switching field is ‘0’, the UE shall switch to BWP #0 in the second BWP set, that is BWP #3 in the first BWP set; if the value of the BWP switching field is ‘1’, the UE shall switch to BWP #1 in the second BWP set, that is BWP #4 in the first BWP set.

According to a second embodiment, the control signal further indicates the activation of a semi-persistent transmission or a configured granted transmission in the activated BWP after switching (e.g., BWP #y).

In a first sub-embodiment of the second embodiment, the activation of the transmission in the activated BWP after switching (e.g., BWP #y) is determined by the UE according to a predefined condition when the UE receives the control signal indicating BWP switching.

A first example of the predefined condition is a comparison between the BWP bandwidth of BWP #x (i.e., the activated BWP before BWP switching) and the BWP bandwidth of BWP #y (the activated BWP after BWP switching). If the bandwidth of BWP #y is equal to or larger than BWP #x, the transmission in BWP #y is activated. If the bandwidth of BWP #y is smaller than the bandwidth of BWP #x, the transmission in BWP #y is deactivated.

A second example of the predefined condition is a comparison between the BWP bandwidth of BWP #y (the activated BWP after BWP switching) and the frequency resource assignment for the transmission. If the BWP bandwidth of BWP #y is equal to or larger than the frequency resource assignment for the transmission, the transmission is activated. If the BWP bandwidth of BWP #y is smaller than the frequency resource assignment for the transmission, the transmission in BWP #y is deactivated.

If the transmission in BWP #y is deactivated, the transmission can be triggered by another control signal.

In the first sub-embodiment of the second embodiment, if the transmission is activated in BWP #y, the transmission configuration associated with BWP #x is adopted to transmission configuration associated with BWP #y. The SPS configuration with BWP #y follows default SPS configuration.

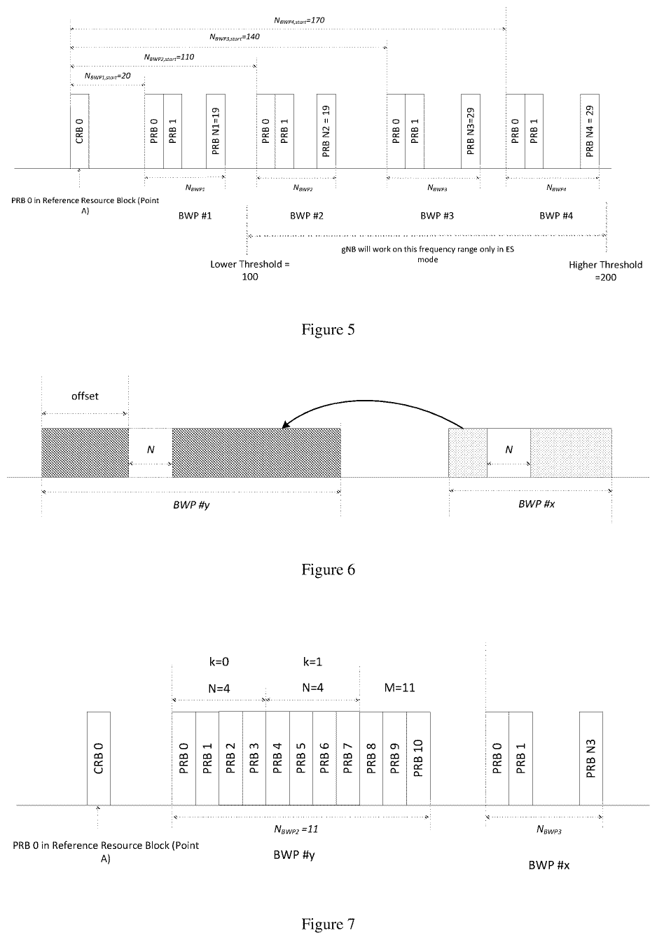

The frequency bandwidth of resource assignment associated with BWP #x is adopted to that associated with BWP #y, and the frequency start of the resource assignment associated with BWP #y is determined by at least one of the frequency start of BWP #y, the frequency end of BWP #y, and the bandwidth of the BWP #y. For example, the start of the frequency resource assignment is determined by an offset to the frequency start of BWP #y, as illustrated in FIG. 6. The offset can be indicated by the control signal, especially when the predefined condition is that the BWP bandwidth of BWP #y is equal to or larger than the frequency resource assignment for the transmission. In addition, the unit of the offset can be determined by the bandwidth of the resource assignment or a default value (e.g., based on gNB SPS scheduling).

FIG. 7 illustrates an example of determining the offset. As illustrated in FIG. 7, the frequency bandwidth of the BWP #y is M (=11) RBs for a given numerology. The bandwidth of the frequency resource assignment is N (=4) PRBs, so the offset can be k*N, k=0, 1, . . . , floor(M/N)−1 (=floor(11/4)−1=2). Two bits can be reserved in the control signal to indicate the offset.

According to a second sub-embodiment of the second embodiment, the control signal includes an activation field to indicate the activation or deactivation of the semi-persistent transmission or the configured granted transmission in BWP #y. For example, the activation field can have one bit, while one value (e.g., value ‘0’) indicates deactivation and the other value (e.g., value ‘1’) indicates activation. The transmission is activated in BWP #y only when the UE receives the control signal including an activation field indicating activation. Similar to the first sub-embodiment, if the transmission is activated in BWP #y, the transmission configuration associated with BWP #x is adopted to transmission configuration associated with BWP #y; the SPS configuration with BWP #y follows default SPS configuration; the frequency bandwidth of resource assignment associated with BWP #x is adopted to that associated with BWP #y, and the frequency start of the resource assignment associated with BWP #y is determined by at least one of the frequency start of BWP #y, the frequency end of BWP #y, and the bandwidth of the BWP #y. In addition, if the start of the frequency resource assignment is determined by an offset to the frequency start of BWP #y, the offset can be indicated by the control signal.

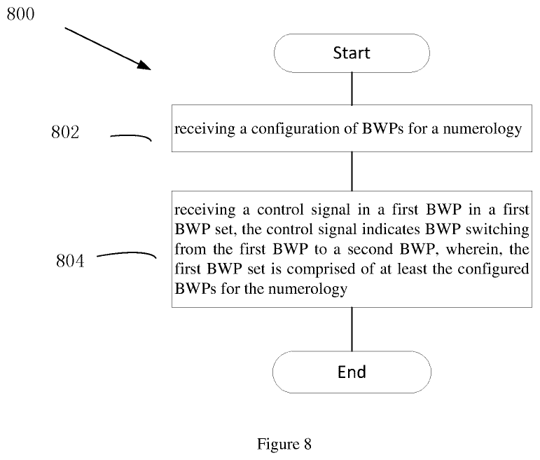

FIG. 8 is a schematic flow chart diagram illustrating an embodiment of a method 800 according to the present application. In some embodiments, the method 800 is performed by an apparatus, such as a remote unit (UE). In certain embodiments, the method 800 may be performed by a processor executing program code, for example, a microcontroller, a microprocessor, a CPU, a GPU, an auxiliary processing unit, a FPGA, or the like.

The method 800 may comprise 802 receiving a configuration of BWPs for a numerology; and 804 receiving a control signal in a first BWP in a first BWP set, the control signal indicates BWP switching from the first BWP to a second BWP, wherein, the first BWP set is comprised of at least the configured BWPs for the numerology.

In some embodiment, the second BWP is one of default BWP, initial BWP, first active BWP and energy saving BWP(s) in the first BWP set, or among the BWPs in the first BWP set, one of the BWP with the highest frequency, the BWP with the lowest frequency, the BWP with the largest frequency bandwidth, the BWP with the smallest frequency bandwidth, the BWP with the lowest BWP index, the BWP with the highest BWP index and some combinations thereof, or among the BWPs in the first BWP set, a single BWP that meets a predefined requirement.

In some embodiment, the second BWP is indicated by the control signal from candidate BWPs in a second BWP set. The candidate BWPs in the second BWP set may be a subset of the first BWPs in the first BWP set.

In some embodiment, each candidate BWP in the second BWP set is one of default BWP, initial BWP, first active BWP and energy saving BWP(s) in the first BWP set, or among the BWPs in the first BWP set, one of BWP(s) with higher frequency(ies), BWP(s) with lower frequency(ies), BWP(s) with larger frequency bandwidth(s), BWP(s) with lower frequency bandwidth(s), BWP(s) with lower BWP index(ices), BWP(s) with higher BWP index(ices) in the first BWP set, and some combinations thereof.

In some embodiment, the second BWP set includes BWP(s) in the first BWP set that meet a requirement. The requirement may be related to at least one of BWP bandwidth, frequency start of BWP and frequency end of BWP. In a first implementation, the second BWP set includes BWP(s) in the first BWP set that have BWP bandwidth not larger than or not smaller than that of the first BWP in the first BWP set. In a second implementation, the second BWP set includes BWP(s) in the first BWP set that have the lowest frequency start of BWP, the highest frequency start of BWP, the lowest frequency end of BWP, or the highest frequency end of BWP. In a third implementation, the second BWP set includes BWP(s) in the first BWP set that are within a frequency range of BWP. The frequency range of BWP may be indicated in the control signal. In addition, the candidate BWPs may be indexed in increasing or decreasing order in the second BWP set according to their BWP IDs in the first BWP set, BWP bandwidth, frequency start of BWP, or frequency end of BWP.

In some embodiment, the control signal further indicates the activation of a semi-persistent transmission or a configured granted transmission in the second BWP. The transmission configuration associated with the first BWP in the first BWP set may be adopted to transmission configuration associated with the second BWP. The bandwidth of resource assignment associated with the first BWP in the first BWP set may be adopted to that associated with the second BWP. The start of the resource assignment associated with the second BWP may be determined by at least one of the frequency start, the frequency end and the bandwidth of the second BWP.

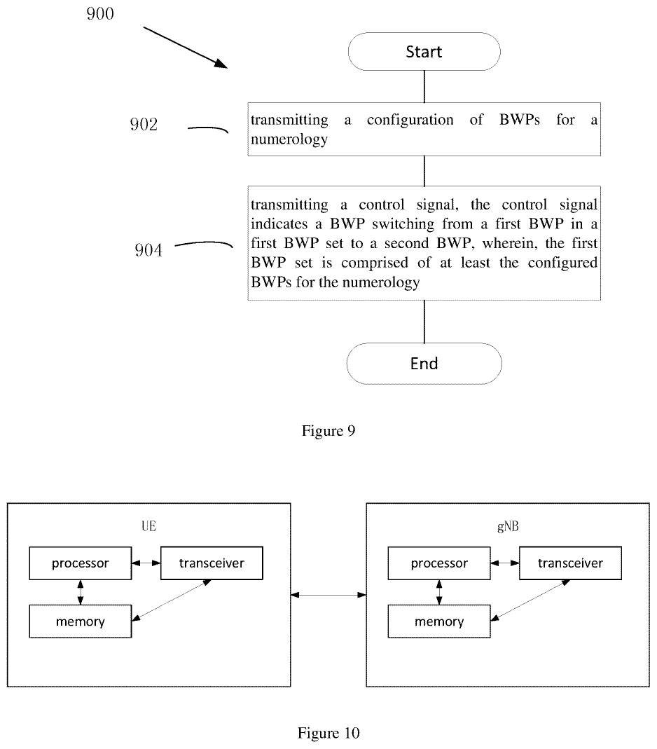

FIG. 9 is a schematic flow chart diagram illustrating a further embodiment of a method 900 according to the present application. In some embodiments, the method 900 is performed by an apparatus, such as a base unit. In certain embodiments, the method 900 may be performed by a processor executing program code, for example, a microcontroller, a microprocessor, a CPU, a GPU, an auxiliary processing unit, a FPGA, or the like.

The method 900 may include 902 transmitting a configuration of BWPs for a numerology; and 904 transmitting a control signal, the control signal indicates a BWP switching from a first BWP in a first BWP set to a second BWP, wherein, the first BWP set is comprised of at least the configured BWPs for the numerology.

In some embodiment, the second BWP is one of default BWP, initial BWP, first active BWP and energy saving BWP(s) in the first BWP set, or among the BWPs in the first BWP set, one of the BWP with the highest frequency, the BWP with the lowest frequency, the BWP with the largest frequency bandwidth, the BWP with the smallest frequency bandwidth, the BWP with the lowest BWP index, the BWP with the highest BWP index and some combinations thereof, or among the BWPs in the first BWP set, a single BWP that meets a predefined requirement.

In some embodiment, the second BWP is indicated by the control signal from candidate BWPs in a second BWP set. The candidate BWPs in the second BWP set may be a subset of the first BWPs in the first BWP set.

In some embodiment, each candidate BWP in the second BWP set is one of default BWP, initial BWP, first active BWP and energy saving BWP(s) in the first BWP set, or among the BWPs in the first BWP set, one of BWP(s) with higher frequency(ies), BWP(s) with lower frequency(ies), BWP(s) with larger frequency bandwidth(s), BWP(s) with lower frequency bandwidth(s), BWP(s) with lower BWP index(ices), BWP(s) with higher BWP index(ices) in the first BWP set, and some combinations thereof.

In some embodiment, the second BWP set includes BWP(s) in the first BWP set that meet a requirement. The requirement may be related to at least one of BWP bandwidth, frequency start of BWP and frequency end of BWP. In a first implementation, the second BWP set includes BWP(s) in the first BWP set that have BWP bandwidth not larger than or not smaller than that of the first BWP in the first BWP set. In a second implementation, the second BWP set includes BWP(s) in the first BWP set that have the lowest frequency start of BWP, the highest frequency start of BWP, the lowest frequency end of BWP, or the highest frequency end of BWP. In a third implementation, the second BWP set includes BWP(s) in the first BWP set that are within a frequency range of BWP. The frequency range of BWP may be indicated in the control signal. In addition, the candidate BWPs may be indexed in increasing or decreasing order in the second BWP set according to their BWP IDs in the first BWP set, BWP bandwidth, frequency start of BWP, or frequency end of BWP.

In some embodiment, the control signal further indicates the activation of a semi-persistent transmission or a configured granted transmission in the second BWP. The transmission configuration associated with the first BWP in the first BWP set may be adopted to transmission configuration associated with the second BWP. The bandwidth of resource assignment associated with the first BWP in the first BWP set may be adopted to that associated with the second BWP. The start of the resource assignment associated with the second BWP may be determined by at least one of the frequency start, the frequency end and the bandwidth of the second BWP.

FIG. 10 is a schematic block diagram illustrating apparatuses according to one embodiment.

Referring to FIG. 10, the UE (i.e., the remote unit) includes a processor, a memory, and a transceiver. The processor implements a function, a process, and/or a method which are proposed in FIG. 8.

The UE comprises a transceiver; and a processor coupled to the transceiver, wherein the processor is configured to receive, via the transceiver, a configuration of BWPs for a numerology; and receive, via the transceiver, a control signal in a first BWP in a first BWP set, the control signal indicates BWP switching from the first BWP to a second BWP, wherein, the first BWP set is comprised of at least the configured BWPs for the numerology.

In some embodiment, the second BWP is one of default BWP, initial BWP, first active BWP and energy saving BWP(s) in the first BWP set, or among the BWPs in the first BWP set, one of the BWP with the highest frequency, the BWP with the lowest frequency, the BWP with the largest frequency bandwidth, the BWP with the smallest frequency bandwidth, the BWP with the lowest BWP index, the BWP with the highest BWP index and some combinations thereof, or among the BWPs in the first BWP set, a single BWP that meets a predefined requirement.

In some embodiment, the second BWP is indicated by the control signal from candidate BWPs in a second BWP set. The candidate BWPs in the second BWP set may be a subset of the first BWPs in the first BWP set.

In some embodiment, each candidate BWP in the second BWP set is one of default BWP, initial BWP, first active BWP and energy saving BWP(s) in the first BWP set, or among the BWPs in the first BWP set, one of BWP(s) with higher frequency(ies), BWP(s) with lower frequency(ies), BWP(s) with larger frequency bandwidth(s), BWP(s) with lower frequency bandwidth(s), BWP(s) with lower BWP index(ices), BWP(s) with higher BWP index(ices) in the first BWP set, and some combinations thereof.

In some embodiment, the second BWP set includes BWP(s) in the first BWP set that meet a requirement. The requirement may be related to at least one of BWP bandwidth, frequency start of BWP and frequency end of BWP. In a first implementation, the second BWP set includes BWP(s) in the first BWP set that have BWP bandwidth not larger than or not smaller than that of the first BWP in the first BWP set. In a second implementation, the second BWP set includes BWP(s) in the first BWP set that have the lowest frequency start of BWP, the highest frequency start of BWP, the lowest frequency end of BWP, or the highest frequency end of BWP. In a third implementation, the second BWP set includes BWP(s) in the first BWP set that are within a frequency range of BWP. The frequency range of BWP may be indicated in the control signal. In addition, the candidate BWPs may be indexed in increasing or decreasing order in the second BWP set according to their BWP IDs in the first BWP set, BWP bandwidth, frequency start of BWP, or frequency end of BWP.

In some embodiment, the control signal further indicates the activation of a semi-persistent transmission or a configured granted transmission in the second BWP. The transmission configuration associated with the first BWP in the first BWP set may be adopted to transmission configuration associated with the second BWP. The bandwidth of resource assignment associated with the first BWP in the first BWP set may be adopted to that associated with the second BWP. The start of the resource assignment associated with the second BWP may be determined by at least one of the frequency start, the frequency end and the bandwidth of the second BWP.

Referring to FIG. 10, the gNB (i.e., base unit) includes a processor, a memory, and a transceiver. The processors implement a function, a process, and/or a method which are proposed in FIG. 9.

The base unit comprises a transceiver; and a processor coupled to the transceiver, wherein the processor is configured to transmit, via the transceiver, a configuration of BWPs for a numerology; and transmit, via the transceiver, a control signal, the control signal indicates a BWP switching from a first BWP in a first BWP set to a second BWP, wherein, the first BWP set is comprised of at least the configured BWPs for the numerology.

In some embodiment, the second BWP is one of default BWP, initial BWP, first active BWP and energy saving BWP(s) in the first BWP set, or among the BWPs in the first BWP set, one of the BWP with the highest frequency, the BWP with the lowest frequency, the BWP with the largest frequency bandwidth, the BWP with the smallest frequency bandwidth, the BWP with the lowest BWP index, the BWP with the highest BWP index and some combinations thereof, or among the BWPs in the first BWP set, a single BWP that meets a predefined requirement.

In some embodiment, the second BWP is indicated by the control signal from candidate BWPs in a second BWP set. The candidate BWPs in the second BWP set may be a subset of the first BWPs in the first BWP set.

In some embodiment, each candidate BWP in the second BWP set is one of default BWP, initial BWP, first active BWP and energy saving BWP(s) in the first BWP set, or among the BWPs in the first BWP set, one of BWP(s) with higher frequency(ies), BWP(s) with lower frequency(ies), BWP(s) with larger frequency bandwidth(s), BWP(s) with lower frequency bandwidth(s), BWP(s) with lower BWP index(ices), BWP(s) with higher BWP index(ices) in the first BWP set, and some combinations thereof.

In some embodiment, the second BWP set includes BWP(s) in the first BWP set that meet a requirement. The requirement may be related to at least one of BWP bandwidth, frequency start of BWP and frequency end of BWP. In a first implementation, the second BWP set includes BWP(s) in the first BWP set that have BWP bandwidth not larger than or not smaller than that of the first BWP in the first BWP set. In a second implementation, the second BWP set includes BWP(s) in the first BWP set that have the lowest frequency start of BWP, the highest frequency start of BWP, the lowest frequency end of BWP, or the highest frequency end of BWP. In a third implementation, the second BWP set includes BWP(s) in the first BWP set that are within a frequency range of BWP. The frequency range of BWP may be indicated in the control signal. In addition, the candidate BWPs may be indexed in increasing or decreasing order in the second BWP set according to their BWP IDs in the first BWP set, BWP bandwidth, frequency start of BWP, or frequency end of BWP.

In some embodiment, the control signal further indicates the activation of a semi-persistent transmission or a configured granted transmission in the second BWP. The transmission configuration associated with the first BWP in the first BWP set may be adopted to transmission configuration associated with the second BWP. The bandwidth of resource assignment associated with the first BWP in the first BWP set may be adopted to that associated with the second BWP. The start of the resource assignment associated with the second BWP may be determined by at least one of the frequency start, the frequency end and the bandwidth of the second BWP.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1-15. (canceled)

16. A user equipment (UE) for wireless communication, comprising:
at least one memory; and
at least one processor coupled with the at least one memory and operable to cause the UE to:
receive a configuration of bandwidth parts (BWPs) for a numerology; and
receive a control signal in a first BWP in a first BWP set, wherein the control signal indicates BWP switching from the first BWP to a second BWP, and the first BWP set comprises at least the configured BWPs for the numerology.

17. The UE of claim 16, wherein, the second BWP comprises one of:
a default BWP, an initial BWP, a first active BWP, or one or more energy saving BWPs in the first BWP set;
among the BWPs in the first BWP set, one of a BWP with a highest frequency, a BWP with a lowest frequency, a BWP with a largest frequency bandwidth, a BWP with a smallest frequency bandwidth, a BWP with a lowest BWP index, a BWP with a highest BWP index; or
among the BWPs in the first BWP set, a single BWP that meets a predefined requirement.

18. The UE of claim 16, wherein, the second BWP is indicated by the control signal from candidate BWPs in a second BWP set.

19. The UE of claim 18, wherein, the candidate BWPs in the second BWP set are a subset of the first BWPs in the first BWP set.

20. The UE of claim 19, wherein each candidate BWP in the second BWP set comprises one of:
a default BWP, an initial BWP, a first active BWP, or one or more energy saving BWPs in the first BWP set; or
among the BWPs in the first BWP set, one of one or more BWPs with at least one higher frequency, one or more BWPs with at least one lower frequency, one or more BWPs with at least one larger frequency bandwidth, one or more BWPs with at least one lower frequency bandwidth, one or more BWPs with at least one lower BWP index, or one or more BWPs with at least one higher BWP index in the first BWP set.

21. The UE of claim 19, wherein the second BWP set comprises one or more BWPs in the first BWP set that meet a requirement.

22. The UE of claim 21, wherein the requirement is related to at least one of BWP bandwidth, a frequency start of a BWP, or a frequency end of a BWP.

23. The UE of claim 21, wherein the second BWP set includes one or more BWPs in the first BWP set that have a BWP bandwidth not larger than or not smaller than a BWP bandwidth of the first BWP in the first BWP set.

24. The UE of claim 21, wherein the second BWP set comprises one or more BWPs in the first BWP set that have a lowest frequency start of a BWP, a highest frequency start of a BWP, a lowest frequency end of a BWP, or a highest frequency end of a BWP.

25. The UE of claim 21, wherein the second BWP set comprises one or more BWPs in the first BWP set that are within a frequency range of a BWP.

26. The UE of claim 25, wherein the frequency range of a BWP is indicated in the control signal.

27. The UE of claim 21, wherein the candidate BWPs are indexed in increasing or decreasing order in the second BWP set according to their BWP identifiers (IDs) in the first BWP set, a BWP bandwidth, a frequency start of BWP, or a frequency end of BWP.

28. The UE of claim 16, wherein, the control signal further indicates activation of a semi-persistent transmission or a configured granted transmission in the second BWP.

29. A method performed by a user equipment (UE), the method comprising:
receiving a configuration of bandwidth parts (BWPs) for a numerology; and
receiving a control signal in a first BWP in a first BWP set, wherein the control signal indicates BWP switching from the first BWP to a second BWP, and the first BWP set comprises at least the configured BWPs for the numerology.

30. The method of claim 29, wherein, the second BWP comprises one of:
a default BWP, an initial BWP, a first active BWP, or one or more energy saving BWPs in the first BWP set;
among the BWPs in the first BWP set, one of a BWP with a highest frequency, a BWP with a lowest frequency, a BWP with a largest frequency bandwidth, a BWP with a smallest frequency bandwidth, a BWP with a lowest BWP index, a BWP with a highest BWP index; or
among the BWPs in the first BWP set, a single BWP that meets a predefined requirement.

31. The method of claim 29, wherein, the second BWP is indicated by the control signal from candidate BWPs in a second BWP set.

32. The method of claim 31, wherein, the candidate BWPs in the second BWP set are a subset of the first BWPs in the first BWP set.

33. The method of claim 32, wherein each candidate BWP in the second BWP set comprises one of:
a default BWP, an initial BWP, a first active BWP, or one or more energy saving BWPs in the first BWP set; or
among the BWPs in the first BWP set, one of one or more BWPs with at least one higher frequency, one or more BWPs with at least one lower frequency, one or more BWPs with at least one larger frequency bandwidth, one or more BWPs with at least one lower frequency bandwidth, one or more BWPs with at least one lower BWP index, or one or more BWPs with at least one higher BWP index in the first BWP set.

34. A base unit for wireless communication, comprising:
at least one memory; and
at least one processor coupled with the at least one memory and operable to cause the base unit to:
transmit a configuration of bandwidth parts (BWPs) for a numerology; and
transmit a control signal, wherein the control signal indicates a BWP switching from a first BWP in a first BWP set to a second BWP, and the first BWP set comprises at least the configured BWPs for the numerology.

35. A method performed by a base unit, the method comprising:
transmitting a configuration of bandwidth parts (BWPs) for a numerology; and
transmitting a control signal, wherein the control signal indicates a BWP switching from a first BWP in a first BWP set to a second BWP, and the first BWP set comprises at least the configured BWPs for the numerology.
